(19) United States
(12) Patent Application Publication
(10) Pub. No.: US 2012/0182431 A1
(43) Pub. Date: Jul. 19, 2012

(54) METHOD AND APPARATUS FOR SHARING A PHYSICAL ACTIVITY BETWEEN SEVERAL PEOPLE

(76) Inventor: Pavel ASANOV, Staten Island, NY (US)

(21) Appl. No.: 13/344,694

(22) Filed: Jan. 6, 2012

Related U.S. Application Data
(60) Provisional application No. 61/433,861, filed on Jan. 18, 2011.
(60) Provisional application No. 61/448,861, filed on Mar. 3, 2011.

(51) Int. Cl. H04N 5/225

(52) U.S. Cl. 348/207.1; 348/E05.024

(57) ABSTRACT

A community system and method for community of users to interact with each other while participating in interactive sessions, such as exercising, playing a game, etc. The community system includes having a plurality of devices, each connected to a user interface, whereby the devices are all connected to a server over the Internet and are operable to interact with each other, and images (either real or avatars) show the orientation and movement of the respective user's bodies.

### RELATED APPLICATIONS

This application claims priority to U.S. Provisional Applications Ser. No. 61/433,861 filed Jan. 18, 2011 and Ser. No. 61/448,861 filed Mar. 3, 2011.

### BACKGROUND OF THE INVENTION

A. Field of Invention

The present application relates generally to a system in which two or more people can participate in a shared activity simultaneously, using common available gaming systems.

b. Description of the Prior Art

Gaming systems allow a user to interact with an electronic game via an interface that generates visual feedback on a display. Historically, the gaming industry supplied users with devices that allowed a user, or player, to interact with an arcade-type game using a remote. The remotes were connected via wires to the gaming device. The gaming device was then connected to a television for user viewing and interaction. Multiple players could play the same game with or against other players if the gaming system allowed multiple remotes to connect to the gaming device.

Recently, gaming systems and devices have evolved to allow a user to interact with the gaming system without the need for a remote connected to the gaming device. These gaming systems include a sensor device or one or more sensors to detect the physical position and orientation of a user's body. This information is then used to depict in real time a graphic representation of the user (frequently referred to as an avatar) on a screen that duplicates the physical movement of the user's body. Such devices include Kinect by Microsoft used in conjunction with Microsoft's X Box, Wii by Nintendo, etc.

One drawback of these gaming systems is that players are confined to interact with other players in the same vicinity as the gaming system. In other words, these gaming systems are used individually and independently of each other with no connection or interaction between users of other gaming systems. Thus, there is a need for a community gaming system that allows users to interact with one another on a more personal level when the users are not located in the same vicinity. Such a system would be of particular interest in the exercise or fitness industry.

Moreover, currently, if one desires to obtain training assistance in exercising, that person must either follow pre-set exercises via exercise videos or the like, visit a fitness club and attend a personal training session, or hire a personal trainer to meet at one's home or other remote location. Deficiencies associated with exercising along with a fitness video include the lack of personal attention and assistance accompanying the workout routine and the inability to modify the routine to obtain personally optimal results.

Additionally, deficiencies associated with hiring a personal trainer, to either meet at gym, home, or other location, include the costs and time association with traveling to a specific location. Furthermore, there is an added cost for those who travel frequently for work or leisure. Specifically, if a personal training session is desired while traveling, one must hire a separate personal trainer through a hotel or local gym in addition to a trainer and gym membership for use while at home. Thus, there is a need for a community gaming system that would allow a user to connect with a personal trainer through his or her home fitness membership.

### SUMMARY OF THE INVENTION

The present invention provides a system including multiple devices disposed at a plurality of physical locations whereby the devices interact with one another to allow respective users to share an experience such as exercising together, playing games with each other, etc.

According to this invention, a screen associated with a first user displays an avatar associated with a second user where the first user's device is located at a separate physical location from the second user's device.

In another aspect of the invention, plurality of devices are disposed at separate physical locations, each device connected to a display, where each display presents to the user of the device avatars representing the users of the plurality of other devices connected to the system.

In one embodiment the system provides remote access to personal trainers for members of a fitness center whereby the personal trainer is able to visually monitor the movements of at least one member in order to critique what the member is doing correctly or incorrectly.

In a second embodiment, users can share the experience by exercising together with or without a trainer.

During each session of shared activity, images of a particular user, a trainer and/or other users are presented on a screen, said images being dynamic by mirroring, mimicking or simulating the actual movement and orientation of the user's body in real time. In another embodiment, the participants are represented on a screen by corresponding avatars moving in synchronism with the bodies of the users.

In summary, there is provided in a first embodiment of the present invention a community system having a plurality of devices, each connected to an output including at least an interface, wherein the plurality of devices are connected to a network server via the Internet. The community system allows a first user to enter the network using a first gaming device, validates the first customer by security credentials, connects the first customer with a second validated customer or a fitness instructor, and visually represents connected second customer or fitness instructor via the interface connected to the gaming device of the first customer.

### BRIEF DESCRIPTIONS OF THE DRAWINGS

The above-described and other advantages and features of the present disclosure will be appreciated and understood by those skilled in the art from the following detailed description and drawings of which

FIG. 1 provides a flow chart a first embodiment of the invention;

FIG. 2 shows a basic flow chart of how participants share an activity using an individual device;

FIG. 3 shows further details of implementation with means for authenticating participants;

FIG. 4 shows a flow chart illustrating an embodiment where the invention is used in a hotel or other similar venue;

FIG. 5 shows a flow chart of implementing the invention as part of a social network;

FIG. 6 shows a flowchart of implementing the invention on a social networking site;

FIG. 7 shows a block diagram of the components of the system constructed in accordance with this invention;

FIG. 8 shows a block diagram of a device used in the system of FIG. 7 used by a participant in a shared activity;

FIG. 8A shows an image of a participant as perceived by the sensor in FIG. 8;

FIG. 8B shows an image of an inanimate object as perceived by the sensor;

FIG. 8C shows a screen shot with an avatar based on the image of FIG. 8A;

FIG. 8D shows a green or blue screen used to separate images of participants from backgrounds;

FIG. 9 shows in a diagrammatic fashion a plurality of servers providing various functions for the system of FIG. 7;

FIG. 10 shows a general flow chart illustrating a commonly shared activity between several participants;

FIG. 11 shows a detailed flow chart for generating images selected by a user during a one-to-one session;

FIGS. 12A and 12B show screen shots generated by the process of FIG. 11;

FIG. 13 shows a detailed flow chart for generating images during a multiuser session; and

FIGS. 14A and 14B show screen shots generated during the process of FIG. 13.

### DETAILED DESCRIPTION OF THE INVENTION

With reference to the figures, there is shown an embodiment of the invention a system and method is presented wherein a community of users participates in a real time (or almost real time) activity. For the purposes of illustration, it is first assumed that the community of users is a plurality of people selectively exercising either together or, on a one-on-one basis with a trainer. In one embodiment of the invention, the common activity is managed and mediated by a central entity such as a fitness center, athletic club or other similar organization. For this purpose, a fitness center allows several customers to sign up to the program (the terms customers, users, clients or participants may be used interchangeably). The center also allows one or more trainers to register on a common network. The system allows several customers to exercise together, with or without a fitness trainer. Alternatively, a customer may elect to exercise with a trainer in a private session.

The fitness center, monitors activities of the customers, as well as trainers, as necessary, over a common network. The network may include servers, data bases, and one or more monitoring stations. Moreover, depending on the agreements between the trainers and the center, the trainers may be compensated either by the customer or the center for each session, based on the length of time of each session, the number of participants, the kind of activity involved, etc. Moreover, the customer may be charged for exercises on a daily, weekly, monthly, or yearly basis, by exercises, etc. In these latter cases, the center may also monitor activities on the net to determine payments to the instructors, charges to the customers, etc.

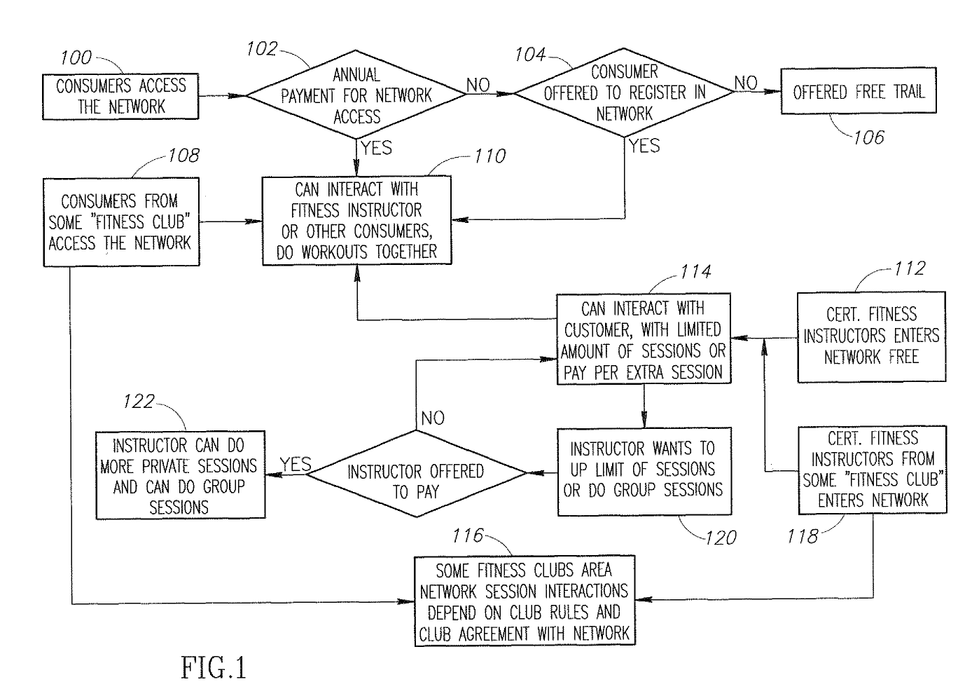

More specifically, starting with FIG. 1, If a consumer is not a member of the fitness center providing the network, he may access it anyway by paying a fee covering, one, or several sessions or based on a time period, Either way, customers enter the network 118 via a device 604 connected to the Internet 602 (FIG. 7, as discussed more fully below). Certified fitness instructors register with the network 112. A fitness instructor may interact with a customer who may have a limited amount of sessions 114. Alternatively, if the customer does not have any sessions, the customer may pay for a session with the instructor 114 and the customer can interact with the fitness instructor or other customers to exercise together 110.

The certified fitness instructor can also decide to increase the limit of sessions or perform a group session 120 and if the certified fitness instructor offers to pay for the increase or group session 122, the certified fitness instructor may take part in ore private sessions and/or instruct group sessions 124.

As discussed above, consumers access the network 100 via the Internet 602 by either providing payments for network access 102 or belonging to a fitness club that provides access to the network 108. If a customer does not belong to a fitness club and is not a current paying member, the customer is offered to register with the network 104. If the customer declines to register, the customer may be offered a free trial 106 to utilize the benefits of the system 600. If the customer chooses to register with the network 104 via the Internet 602, the customer may then interact with a fitness instructor or other customers to exercise together 110.

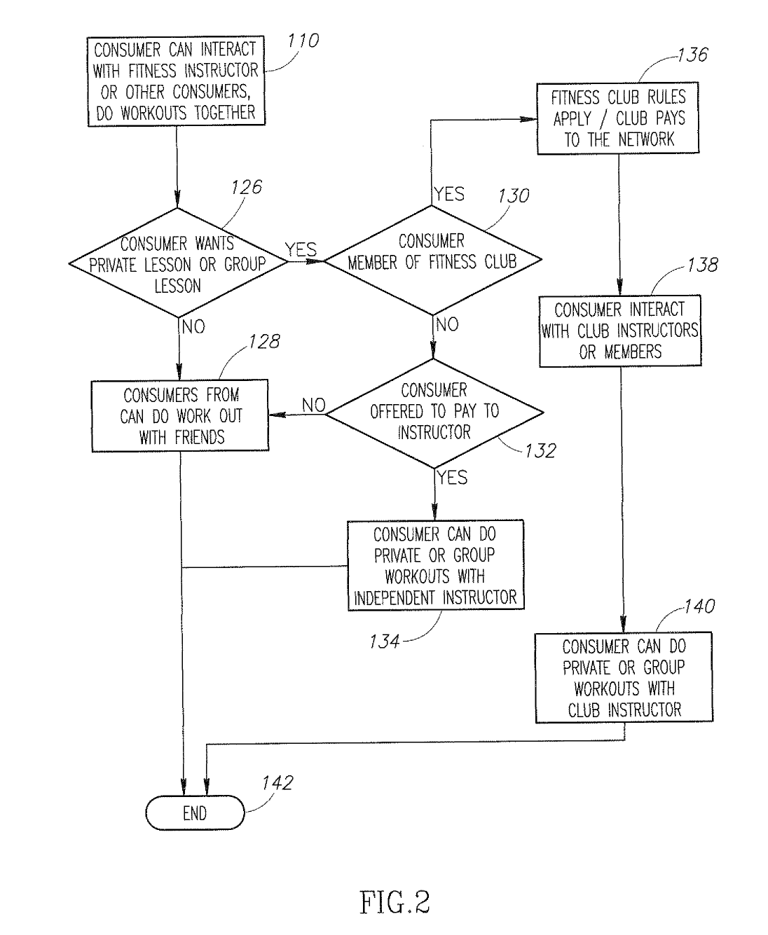

FIG. 2 illustrates how customers may interact with the system 600. A customer may choose to select private lesson or a group lesson 126. If a customer does not want a private lesson or a group lesson, a customer may then instead choose to work out with friends 128. If a customer wants either a private or a group lesson, the system must determine if the customer is a member of a fitness club 130. If the customer is a member of a fitness club 130, the fitness club rules will apply and the fitness club will pay the network 136. If the customer does not belong to a fitness club, the customer may then select whether or not to pay for an instructor 132. If the customer does not wish to pay for an instructor, the customer may then utilize the system 600 to interact with other non-instructor users and interactively work out together 128. If the customer desires to pay for an instructor, the customer can choose to either join a private or group workout with that instructor and begin an interactive workout routine using the gaming system 600.

Since users are able to utilize individual devices 604 in order to interact over the Internet 602 and work out with other users, each device 604 is also equipped with an interface 606 which can display an avatar for a respective user associated with the device 604 together with avatars of other users at other locations on other gaming devices 604. Preferably, voice channels are also provided that allow two or more users to talk to each other during a shared activity. When the respective avatars of all or some of the participants are presented on each of the interfaces 606 associated with each device 604, each avatar will mimic in real time the movements of each of the participants. The audio channels provide a means of allowing the participants to talk to each other. In one embodiment, the instructor can select one or more of the other participants to give them private tutoring or training of what they are doing right or wrong.

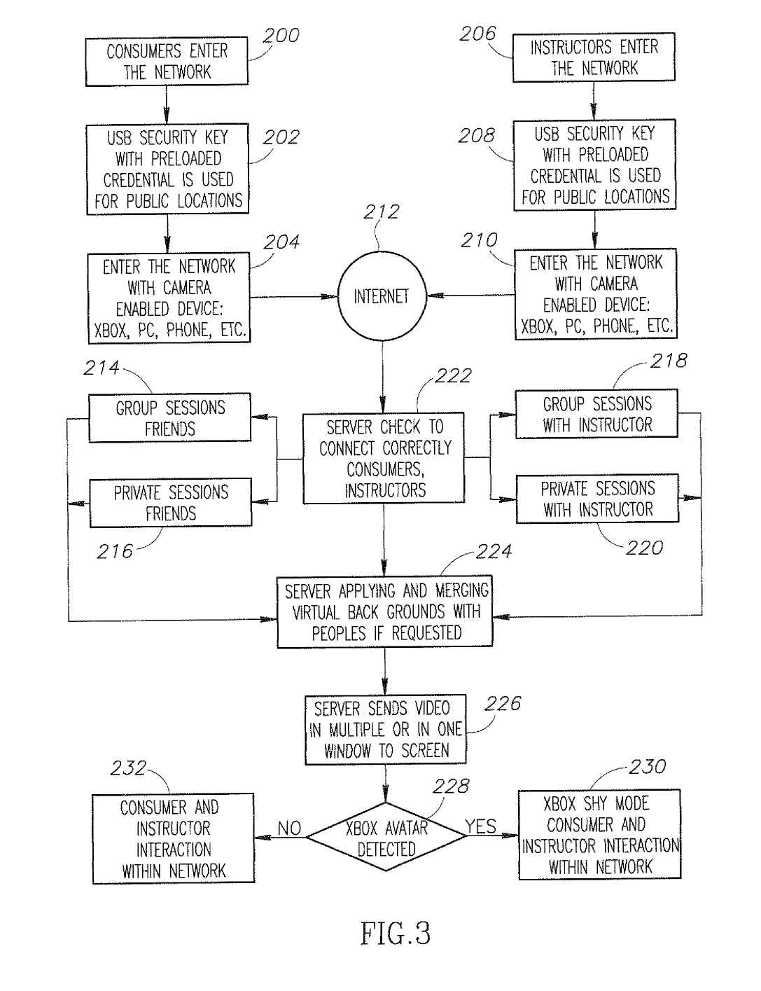

FIG. 3 illustrates the details of how participants, including customers and instructors, enter the system and are authenticated. First, either a costumer enters the network 200, or an instructor enters the network 206. Each participant, including each customer and each instructor, is given a USB security key. In one embodiment, each USB key has preloaded credentials so that a customer may use it in public locations 201. Furthermore, an instructor may also use the preloaded USB security in a public location 208. Next, the participant enters a facility (unless he is at home or at the fitness center) where a device is available with a camera (e.g., an interactive device, personal computer, phone, etc.) 204, 210 and connects to the Internet 212.

Once a participant is connected to the Internet 212, a server checks to ensure that customers and instructors are correctly connected 222. Once this check is complete, a customer may select to take part in a group session with friends 214, a private session with a friend 216, a group session with a fitness instructor 218, or a private session with a fitness instructor 220. The server then merges the connected participants sessions 224 such that the virtual backgrounds are merged between a customer and any requested participant (e.g., a friend or an instructor).

The server sends video in multiple screens or in one window screen depending on how many participants are requested 226. The system then determines whether an avatar is detected for each participant 228 and, if so, the user may utilize their avatar (as opposed to a live video feed) in order to interact within the network 230. Thus, the requested participant's avatar will appear on the requestor's interface 606 and mimic in real time the movements of the requested participant 226. In other words, if the requestor is a customer who requests a private session with a fitness instructor, the server will send real time avatar representation of the instructor to the customer shown through the customer's interface 606 and an avatar representation of the customer to the instructors shown through the instructor's interface 606. If the system does not detect an avatar for a participant, the participant may still interact within the network, but may need to utilize live video feed to do so 232.

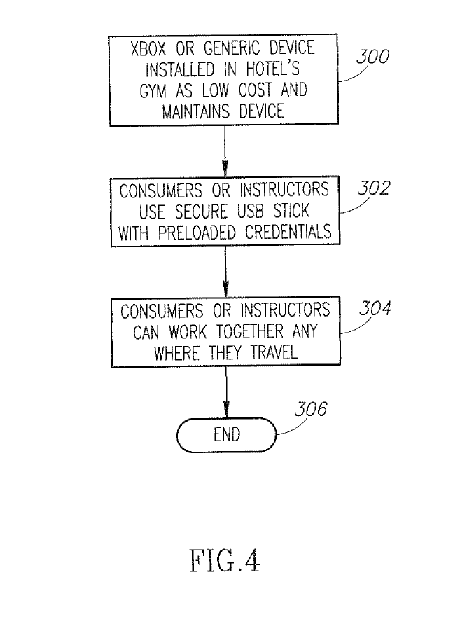

With reference to FIG. 4, one of the benefits of the community system 600 is that each of the participants can be participating at home or at a different location, such as a gym, hotel, etc. In one embodiment, a gaming device 604 is installed in a non-home location, such as a hotel gym 300. Customers and/or instructors may then use their respective secure USB drive with preloaded credentials to participate in an interactive session 302. This embodiment allows customers or instructors to maintain interaction anywhere they travel 304.

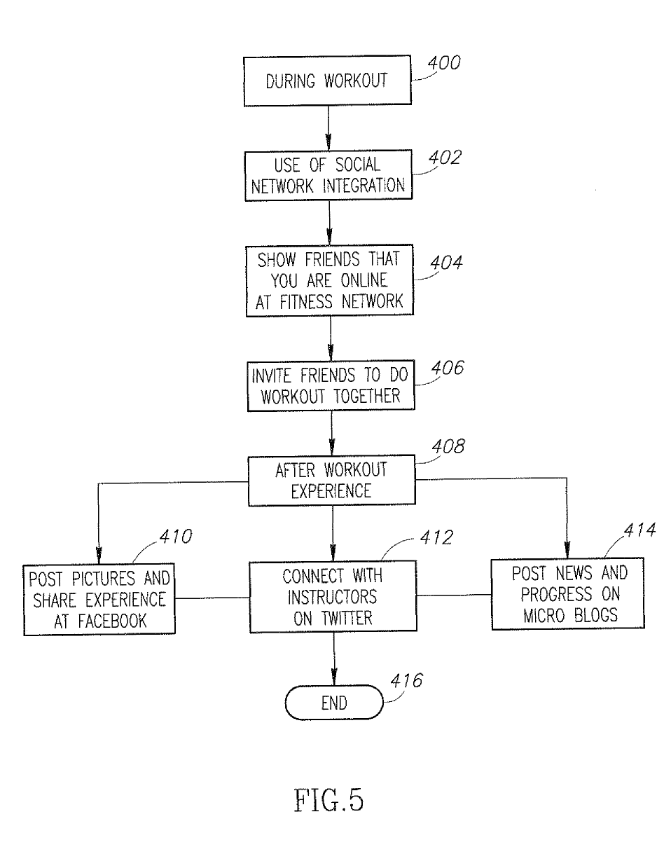

FIG. 5 illustrates a further embodiment of the system 600. When a participant is interacting with the community system during a workout 400, the participant may also integrate their workout into their respective social networking accounts 402 over the Internet 602. A participant may, in real time, let his or her social network know that he or she is actively using the community gaming system 404 and invite members of his or her social network to workout 406. Furthermore, a participant may also integrate past workouts into information available over a social network 408. A participate may post pictures and share thoughts about the experience over the social networking website 410, connect with instructors over the social network 412, or post progress over networking and other websites 414.

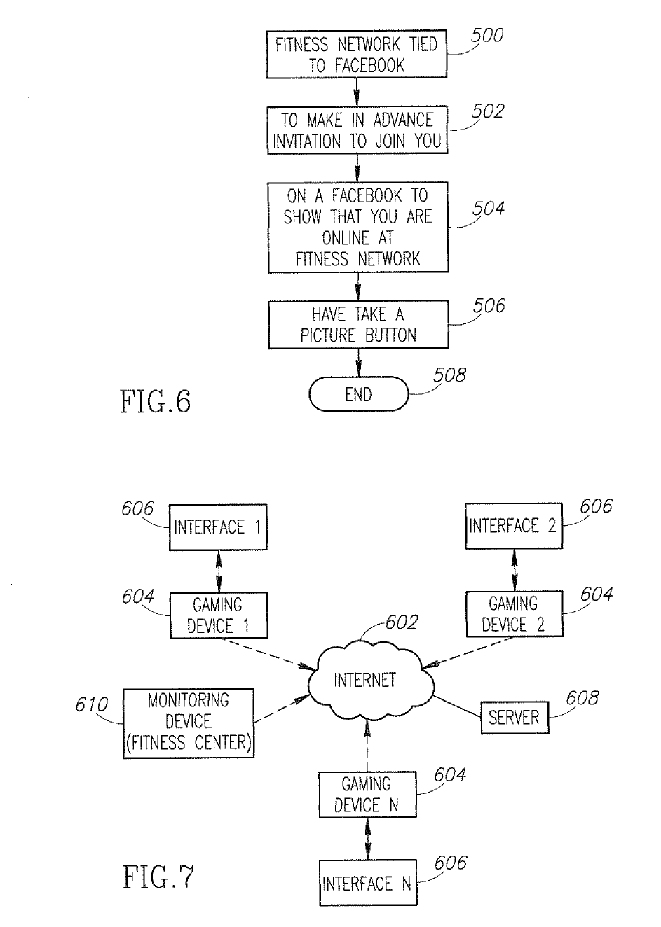

FIG. 6 illustrates how the community system 600 may be further incorporated into a social networking website. The community system 600 can send, over the Internet 602 to a social networking site, real time status of a fitness network 500 associated with the community system 600. A participant may post future workouts and invite members of his or her social network to join in the future workouts 502. The connection between the community system 600 and a social network website may also allow members of a social network to view who is actively using the community gaming system 600 so that members of a social network may join a session on the community gaming system 504. Finally, since the community system 600 utilizes video technology, a participant may take a picture or a screen shot of the participants on the interface 606 and upload or post any pictures or graphics to a social networking website 506.

In an alternative embodiment, the shared or joined activity of this kind may be used as a fund raiser in which one or more participants are well known celebrities. This would attract more participants and induce them to join the function and donate money to a charity.

In another embodiment, in order to make the activity more entertaining, the movement of a participant can be used to simulate movement through virtual reality of any real setting, such as walking or running, on the street of a well-known city, or even imaginary setting (e.g., walking on the moon or the Starship Enterprise from Star Trek). During this activity, several avatars can be presented as moving in a group thereby further accentuating the sharing experience. The avatars are preferably selected by each user based on his/her preferences. For example, the avatar may be a likeness of the person based on a sketch or a photograph provided by the user or taken by the device. Alternatively, the users may select avatars arbitrarily or, using the likeness of favorite cartoon characters, such as Disney characters or real live persons such as movie stars or famous singers.

In another embodiment of the invention, the screen represents 3D images and the participant can be given an even more realistic virtual sharing experience with or without 3-D glasses.

The systems, methods and computer program products of the present invention may be implemented through technologies that are now known or that come to be known that may be appreciated by persons of ordinary skill in the art as being of use in connection with the present invention.

The system may be implemented through one or a plurality of computers or central processing units. The computers having a processor that can execute instructions and manipulate data and other inputs. The system may be implemented using a computer program, which includes instructions that can be stores on hardware, software, or a combination of both. The system may have specific software that standardizes communication with network servers. Such network servers include any device capable of sending and receiving electronic data. Furthermore, a server may have a storage device, an input device, an output device, a memory device, a processor and a communication interface in order to effectively provide a community gaming system.

An input device may be any device that may be used to input, select, or manipulate data. For example, an input device may include, but is not limited to, a keyboard, a remote, a sensor, a microphone, and a graphic tablet. An output device may constitute any device that presents information to a user, including, but not limited to, a video or visual display and an audio component. A communication interface includes means for receiving and sending data, such as a modem, network interface card, and software that allows for protocol and data conversion.

In another embodiment, the present invention provides a computer program stored in a tangible medium. The medium may be a non-transitory tangible computer readable storage medium comprising a set of executable instruction that are capable of directing a computer to execute the necessary steps for the community gaming system to perform its intended purpose. The non-transitory computer readable storage medium may include hardware, software, or a combination of the two, which directs a computer to perform certain functions.

FIG. 7 shows a block diagram of the system 600 used for implementing the present invention. The system 600 includes a plurality of devices 604, each device 604 being associated with an interface 606 for interfacing with a customer or instructor. As discussed in more detail below, in a preferred embodiment, the device 604 is a gaming device such a Microsoft Kinect.

Each device is connected to a networking means such as the Internet 602. In addition, a monitoring device 610 is also provided to allow personnel to monitor what is going on the system 600 live 24/7, or at regular intervals. A server member 608 is used to implement and control the connections and interplay between the various devices 604 and to collect data for the monitoring device 610.

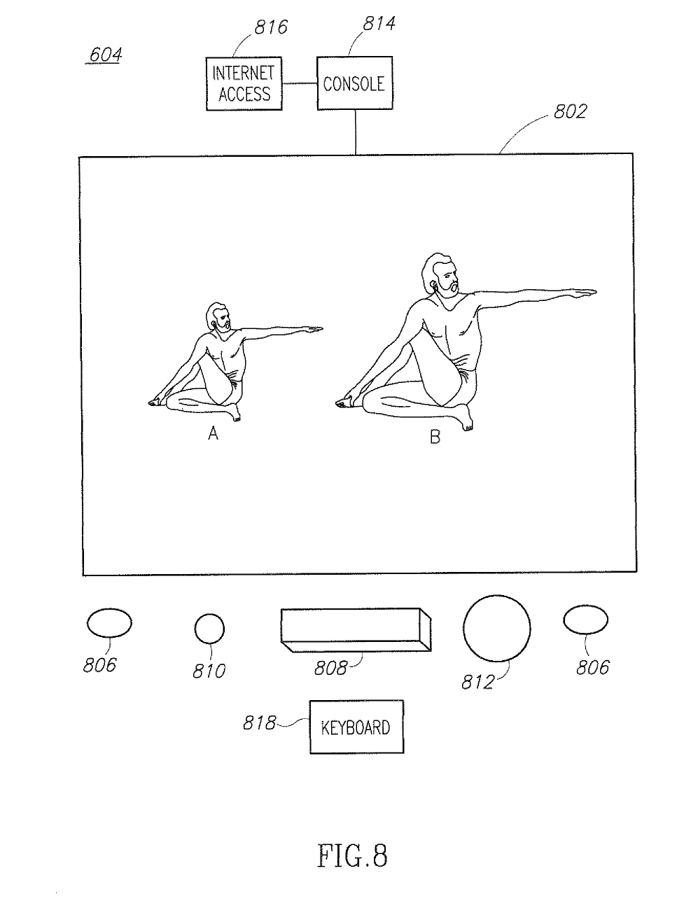

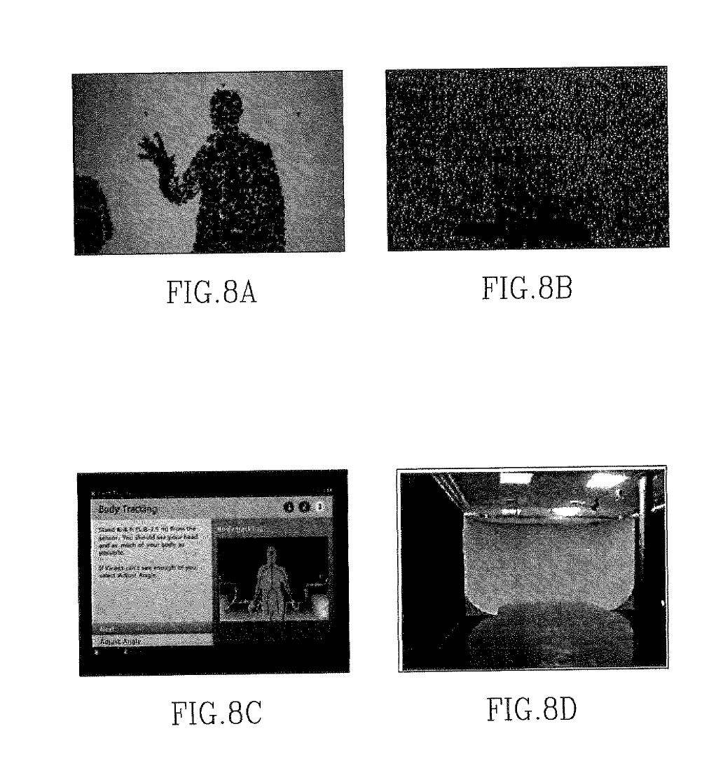

FIG. 8 shows a block diagram of a typical device 604 used in the system 600 and can be used by one or more customers or instructors. As previously mentioned, the device can be implemented using a Microsoft Kinect device coupled to an X-box, a screen and other elements as described. The device 604 includes a screen 802. This screen is used to provide the customer with instructions on how to use the system, other related information, as well as live images, such as images A and B.

The device 604 further includes speakers 806 and a microphone 810 through which an instructor or customer can talk to other participants on the system. The device includes a sensor and/or a camera 812, as well as a console 814 with a microprocessor (not shown0 that controls the operation of the device. The console 814 includes or is associated with an internet access device 816 providing access to the internet. The device 604 may include, optionally, a keyboard 818.

Importantly, the sensor 808 is a motion and 3D sensor that can sense not only an outline of objects or a participant's body but also, if the participant is moving, can generate a digital representation of various key target points on the body. FIG. 8A shows how the body of a participant is digitally represented using information from sensor. For example, FIG. 8A shows data points representing the body of a participant while FIG. 8B shows how several still objects are represented. As mentioned before, these representations can be two or three dimensional.

When a participant is standing before sensor 808, an image can be presented on the screen as shown in FIG. 8C showing an avatar imitating the position of the participant's body. An avatar can be automatically assigned to a participant, or a participant may chose or design one for himself. Alternatively, a picture may be taken of the participant using camera 812 and the image may be used to create the avatar. Importantly, the device can also be used to as a green (or blue) screen when generating or representing the avatar so that the image of the avatar can be separated from any real or virtual background and superimposed on other images.

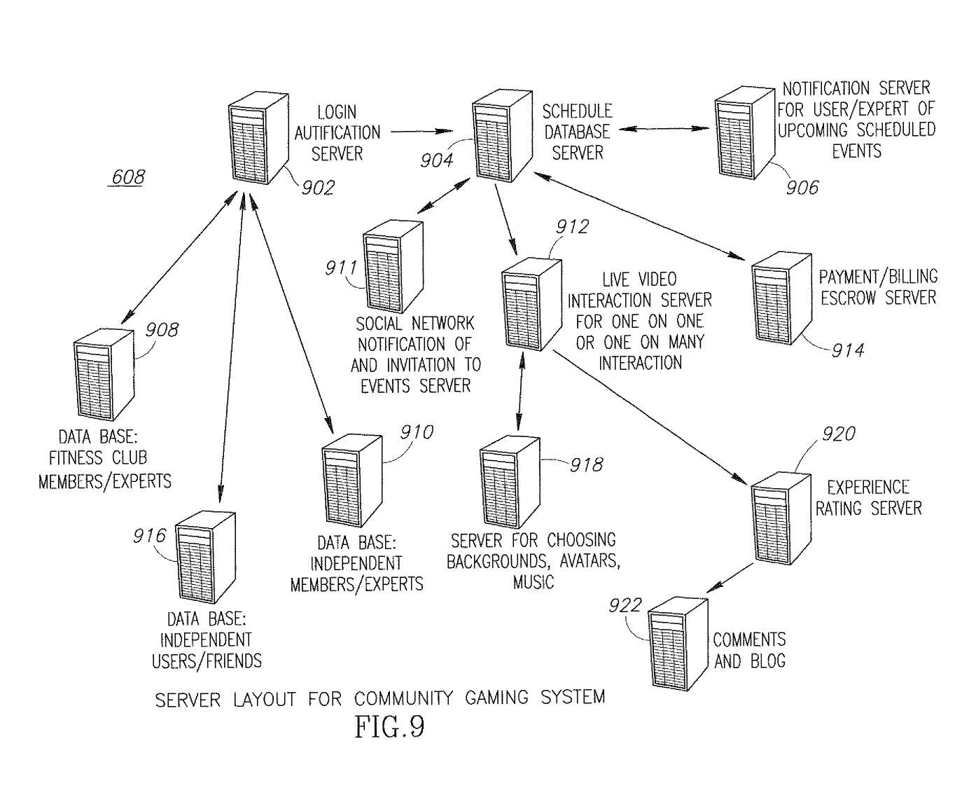

In FIG. 7 a single server member 608 is used symbolically to represent one or more elements used for interconnecting and controlling the system. However, the server members 608 may include several elements, each performing different functions. For example, as illustrated in FIG. 9, server member 608 may include the following:

A login authentication server 902 used to identify and authenticate users and trainers as they log into the system 600;

A schedule data base server 904 that keeps track of various events or community activities, including past, current and future (scheduled activities);

A notification server 906 that notifies trainers and users of future events, including payments (For example, a trainer may schedule community exercise sessions for every Tuesday night at 8 PM New York time. Then various users may sign up for the sessions from anywhere in the world. At a predetermined time prior to the scheduled event, both the users and the trainers receive reminders that event is coming up);

A data base 908 listing all the members of the fitness club and all the trainers who have signed up and are available to participate in events;

A data base 910 of persons or even trainers who have signed up but are not members of the fitness club (this may include users/trainers from associated fitness clubs);

A social network server 911 that presents information on public social networks about events scheduled on the system 600;

A Live video interaction server that manipulates and feeds live video signals between several users and, optionally, a trainer, showing live broadcasts of the participants;

A payment/billing server 914; A data base of independent users who have not signed up yet but may be potential members and should receive announcements of events;

A server 918 used for storing images of avatars and background images that are either generic or customized and may be associated with specific participants.;

A server 920 collecting ratings about trainers and other information related to an event; and

A server 922 collecting comments and blogs about events or other related information,

The information from the servers is available for monitoring and other purposes to the monitoring device 610.

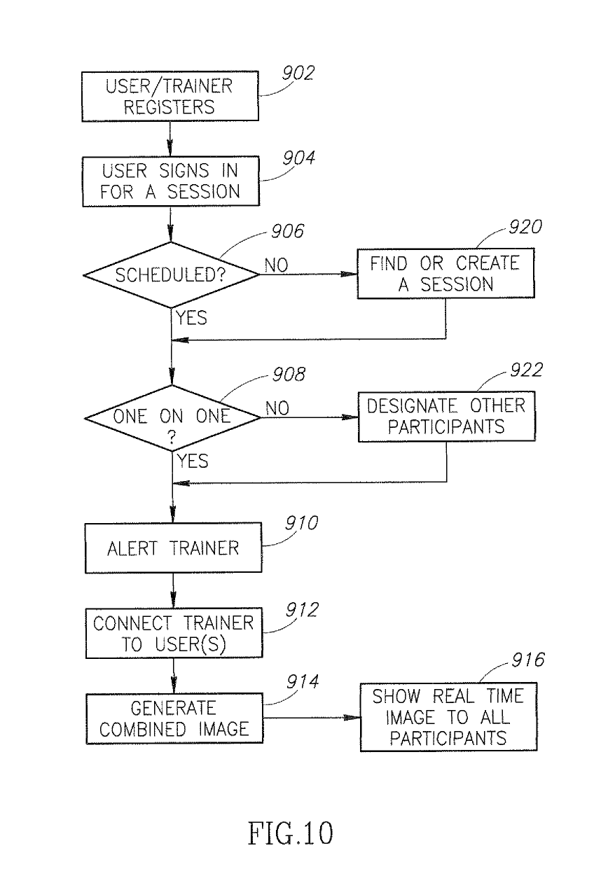

The operation of the system 600 for a single session is summarized in FIG. 10. In step 902 the various users and trainers register with the system. In step 904 a user wants to participate in a session for a shared activity so he signs in. In step 906 a check is made to see if the user is scheduled to participate in any on-going sessions or sessions that are about to start. If yes, then the user is asked if he would like to participate in a one-on-one session.(step 908). In step 908 a trainer is alerted that a session is about to start and that the user is ready. Both the trainer and the user activate their respective device at this time (unless they have done so earlier).

Going back to step 906 if the user has not been scheduled for a session, then in step 920, a session is found or created for the user, depending on whether there are any free trainers available, or if there are any on-going sessions that the user can participate in. Again, the user can participate in a one-one or a multiple user session.

If in step 908 the user indicates that he wants to multiple user session, then in step 922 the user can either designate other users for the session, or can be presented with a list of users available on line to participate in a session with the user. The user can also elect (or schedule ahead of time) a session with or without a trainer. All the participants, including the trainer, if any, are alerted that the session is about to start and they should activate their devices. In step 912 the trainer (if any) and the user(s) are connected by the appropriate server(s). In step 914 a combined image showing some or all the participants in real time is generate. This step is facilitated by the fact that some or all the images are created with a blue or green screen and therefore they can be readily separated from the respective backgrounds, superimposed on a single image, Optionally, the single image may include real or virtual background as well. The single image is then presented to the participants (including the trainer) in step 916.

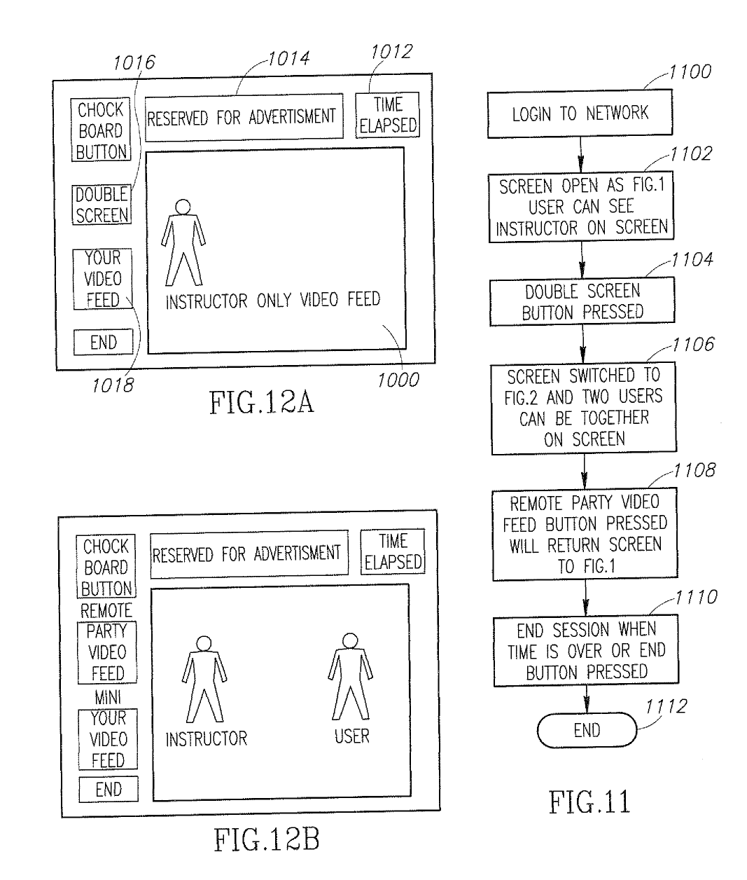

FIG. 11 shows a flow chart with more details of how the images are generated and FIGS. 12A and 12B show composite images on the screens of the user or the trainer for a one-on-one session. The composite image of FIG. 12A includes a main region 1000 for the real time images. Several other regions are dedicated for control functions or other features. More specifically, region 1012 shows the time elapsed since the session has started. Region 1014 is used for presenting advertising or announcements from the fitness center or other information. Region 1016 is a control button to select the single or double screen mode (discussed more fully below). Region 1018 is a control button used to select which real time image is being presented.

Referring to FIG. 11, in step 1100 the user logs in and the process is initiated.

In step 1102 (after the process of FIG. 10 is completed) the image of FIG. 12A appears on the screen 802 in a single mode showing only an image of the instructor.

The user can leave the screen in this mode, or he can activate the double screen mode (region 1016) and the screen shows an image of the user and the instructor side by side, as seen in FIG. 12B (step 1104). At any time, the user or the instructor can activate region 1016 and the instructor will appear again as in FIG. 11A. Alternatively, either party can activate region 1018 and the user's image appears instead of the trainer's (step 1108). In an alternate embodiment, one button (e.g., region 1016) is always used to show the image from the local device and the other button (e.g., region 1018) is always used to show the image from the remote location.

At the end of the session (step 1110) the device is deactivated and the process is terminated (step 1112).

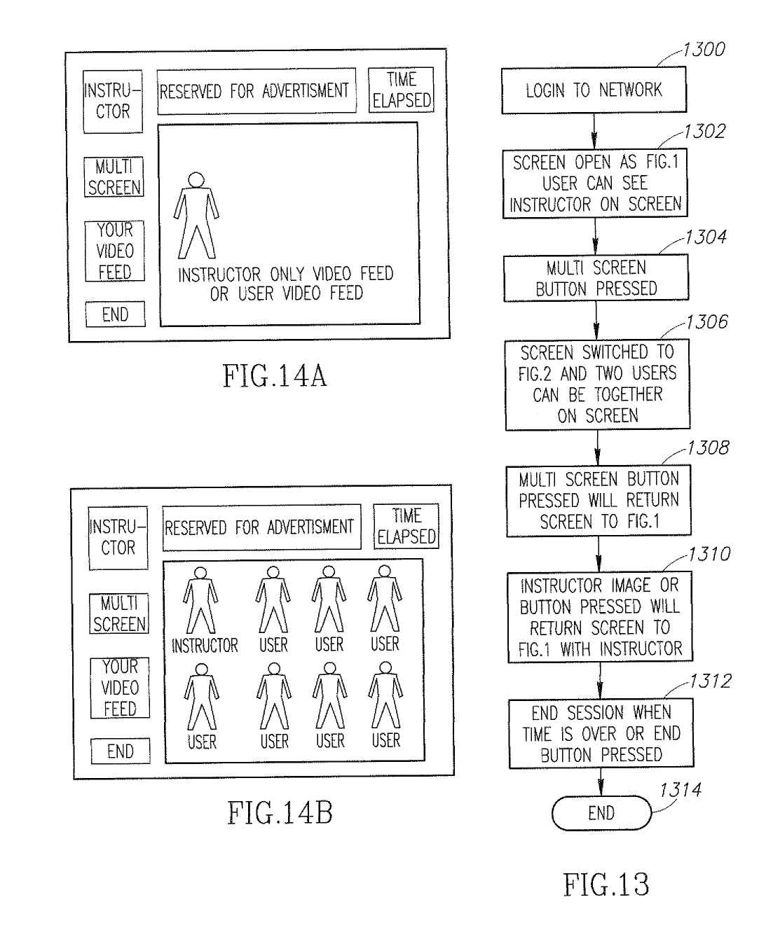

FIGS. 13, 14A, 14B show the flow chart and screen shots for a multiuser session. In step 1300 a user signs up. In step 1302 an image appears as shown in FIG. 14A showing initially only the trainer. In step 1304, the user requests a multiscreen mode and all or at least some of the other participants are shown arrange in an array as shown in FIG. 14B (step 1308). One of the participants may or may not be a trainer. The user can switch back and forth between the two screen shots as desired (step 1310). The session ends at step 1312 and the process is then deactivated (step 1314).

Importantly, as previously described, the image or images on the screen are in real time (except for any delays due signal propagation and signal processing time within the system.) The images can be either avatars, real images obtained from the camera 812 or both. For avatars, the sensor used to monitor the body movement of each user senses the relative locations of a plurality of points on the body and transmits them to the controller which then calculates what is the corresponding position of the user and generates an image of the avatar in the same position as the user.

In this manner, the trainer can demonstrate a particular exercise. The user can watch the trainer and either imitate him or both can repeat the exercise as desired. During the exercise, the trainer can watch and critique the user's performance as presented on the screen. In the multiuser mode, a participant can see all, or at least a some group of the participants and the experience of exercising in the fresh air is shared between the various users.

In the above description, the invention has been described as being used within a community of users for sharing visually and aurally a specific activity—exercising. However the invention can be used for other activities as well. For example, can play a game with each user being able to see on his own screen not only his own image but the images of other users in real time, simultaneously. The avatars are animated electronically so that they simulate or mimic the actual real live movements of the participants, and that is what is presented on the screen. The movement of the participants is sensed directly by sensor 808. In an alternate embodiment, remotes (not shown) are provided (for example if a Wii gaming device is used instead of Kinects and X-box) and sensors then monitor the position and orientation of the remotes and the results are used to extrapolate or calculate the positions and orientations of the users. The system can be used with all users having a sensor 808, all users having remotes similar to the Wii system, or a hybrid configuration may be used in which some participants are represented by real images while others are represented by avatars.

The images of the participants are selected by the user or the gabing platform and may or may not look close to what the participants look like in real live. In an alternate embodiment, real moving images of the participants are captured by camera 812.

The accompanying drawings only illustrate a community system, its constituent parts, and method of use. However, other types and styles are possible, and the drawings are not intended to be limiting in that regard. Thus, although the description above and accompanying drawings contains much specificity, the details provided should not be construed as limiting the scope of the embodiment(s) but merely as providing illustrations of some of the presently preferred embodiment(s). The drawings and the description are not to be taken as restrictive on the scope of the embodiment(s) and are understood as broad and general teachings in accordance with the present invention. While the present embodiment(s) of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention. It should also be noted that the terms “first,” “second” and similar terms may be used herein to modify various elements. These modifiers do not imply a spatial, sequential, or hierarchical order to the modified elements unless specifically stated.

I claim:

1. A method of sharing a physical activity by a community of members, wherein each member is associated with a device including a display and a sensor at a member location, comprising:
acquiring a first moving image representing a body movement of a first member of said community with the respective sensor as said member is involved in a physical activity;
receiving a second image representing a body movement of another member over a distributed computer network by said device; and
presenting on said display said first and second images side by side.

2. The method of claim 1 wherein said images have the same size.

3. The method of claim 1 wherein said device further provides a background image on said display with said two images being presented in front of said background image.

4. The method of claim 1 wherein said sensor monitors a plurality of points on said member's body, determines the relative positions of said points and said device determines said movement based on said relative positions.

5. The method of claim 1 wherein said community includes a first member, a second member and a trainer.

6. The method of claim 5 wherein said second image is related to said trainer.

7. The method of claim 6 wherein said display presents images related to said first and second member.

8. The method of claim 6 wherein said display presents images of two members.

9. The method of claim 1 further comprising a selection element used to select what images are shown in the display.

10. A device for sharing a physical activity between a local member and a remote member of a community, said members being involved in a common physical activity but being disposed at different geographic locations, said device comprising:
a controller;
a display operated by the controller;
a sensor configured to sense a body movement of said local member; and
an interface coupled to said controller and receiving a remote image related to the body movement of a second member at a remote location;
wherein said controller is adapted to generate an image representative of the movement of the body of the first member based on an input from said sensor, and to generate a composite image on said display, said composite image including said local and said remote images.

11. The apparatus of claim 10 further comprising a selection element operated by the local member to select images for the display.

12. The apparatus of claim 10 wherein said controller generates an avatar for said local image.

13. The apparatus of claim 10 wherein said first and images have the same size.

14. The apparatus of claim 10 wherein said interface receives several images from several members and said controller incorporates said several images into said composite image.

15. A computer based method for providing a shared physical activity between several members comprising:
establishing a data base on a computer system, said data base including a plurality of members, each member being associated with a device including a controller, an interface with said computer system, display and a sensor sensing body movement of the respective member;
initiating by said computer system of a common activity session;
establishing a communication through the respective interfaces between said computer system and said members;
transmitting by said computer system images of other members as they are participating in said physical activity;
generating by each device a composite image on said display, said composite image including at least two images associated with said members.

16. The method of claim 15 wherein said composite image includes an image of the member associated with said device.

17. The method of claim 15 wherein said community includes at least one trainer, said trainer providing information to said computer system for initiating said common activity session.
